(19) United States
(12) Patent Application Publication
(10) Pub. No.: US 2024/0111915 A1
(43) Pub. Date: Apr. 4, 2024

(54) EVALUATION SITE ACCURACY CONTROL METHOD AND PRODUCTION METHOD

(71) Applicant: HONDA MOTOR CO., LTD., Tokyo (JP)

(72) Inventors: Jun SHIWAKU, Tokyo (JP); Yutaro INOUE, Tokyo (JP); Kota KOBAYASHI, Tokyo (JP)

(21) Appl. No.: 18/363,757

(22) Filed: Aug. 2, 2023

(30) Foreign Application Priority Data
Sep. 29, 2022 (CN) 202211213208.2

(51) Int. Cl. G06F 30/13; G06F 30/23

(52) U.S. Cl. CPC G06F 30/13; G06F 30/23

(57) ABSTRACT

Provided is a production method for a completed component, the production method including: a first step for performing finite element analysis to determine an amount of change at evaluation sites of the completed component on a three-dimensional model of the completed component that occurs when displacement is applied to joining areas between the individual parts on the three-dimensional model; a second step for extracting combinations of critical evaluation sites having a relatively large amount of change among the evaluation sites on the three-dimensional model and their corresponding critical joining areas among the joining areas on the three-dimensional model; a third step for generating regression models through Lasso regression; a fourth step for performing Bayesian estimation; a fifth step for selecting an adjustment site of the individual parts; and a sixth step for producing the completed component.

### CROSS REFERENCE TO RELATED APPLICATIONS

This application claims the benefit of priority to Chinese Patent Application No. CN202211213208.2 filed on Sep. 29, 2022. The entire contents of this application are hereby incorporated herein by reference.

### BACKGROUND OF THE INVENTION

### Field of the Invention

The present disclosure relates to an evaluation site accuracy control method and a production method. More particularly, the present disclosure relates to simulation-assisted estimation of polynomial model contribution probability distribution for vehicle assembly.

### Related Art

Japanese Unexamined Patent Application, Publication No. 2006-264521 discloses a technique involving the following processes. Preset assembly positions are measured and taken as assembly position data for each assembly process of a plurality of parts and vehicle components. The assembly position data is stored, or accumulated. The assembly accuracy of a plurality of assembly positions in a completed vehicle is measured and taken as reference assembly position data. Using the reference assembly position data as objective variables and the assembly position data of the plurality of parts or vehicle components as explanatory variables, one or more assembly position data points that can have a relatively significant impact on the reference assembly position data, for example, parts or position data in a sub-assembly process, are identified based on regression analysis.
Patent Document 1: Japanese Unexamined Patent Application, Publication No. 2006-264521

### SUMMARY OF THE INVENTION

The desired value for a correlation coefficient, or multiple correlation coefficient, which serves as an index to determine whether or not a set regression equation accurately reflects actual measurement values, needs to be set to, for example, 0.8. However, the greater the number of objective variables, the larger the amount of data is needed to obtain an accurate correlation coefficient. For the larger amount of data, a larger number of workpiece vehicles are necessary. However, in a prototyping stage before mass production, it is difficult to secure a sufficient number of workpiece vehicles, and it is required to derive regression equations that demonstrate correlation using a limited amount of data. An object of the present disclosure is therefore to provide an evaluation site accuracy control method and a production method that allow for deriving regression equations that demonstrate correlation with respect to the part accuracy using a small amount of data.

A production method according to the present disclosure is a production method for a completed component that is composed of a combination of a plurality of individual parts, the production method including: a first step for performing finite element analysis to determine an amount of change at evaluation sites of the completed component on a three-dimensional model of the completed component that occurs when displacement is applied to joining areas between the individual parts on the three-dimensional model; a second step for extracting combinations of critical evaluation sites having a relatively large amount of change among the evaluation sites on the three-dimensional model and their corresponding critical joining areas among the joining areas on the three-dimensional model; a third step for generating regression models through Lasso regression using, as explanatory variables for each regression model, actual measurement data of joining areas of uncombined real individual parts corresponding to the critical joining areas and using, as an objective variable for each regression model, actual measurement data of an evaluation site of a real completed component corresponding to the critical evaluation sites; a fourth step for performing Bayesian estimation using each regression model and relationship between the explanatory variables and the objective variable obtained using the actual measurement data to obtain partial regression coefficient probability distribution; a fifth step for selecting an adjustment site of the individual parts based on mean and spread of the partial regression coefficient probability distribution if the measurement data of the evaluation sites of the completed component includes a value exceeding a permissible value; and a sixth step for producing the completed component using the individual parts in which the adjustment site has been adjusted.

This method makes it possible to reduce the number of objective variables by identifying critical evaluation sites and critical joining areas using a three-dimensional model, and to obtain regression models aligned with evaluation on actual parts by incorporating actual measurement data in creating the regression models. This method also makes it possible to select objective variables that take into account tendency of actual parts, which in other words are joining areas of individual parts that have a high contribution to the evaluation sites, by predicting partial regression coefficient probability distribution through Bayesian estimation. As a result, it is possible to effectively adjust an evaluation site. This method also makes it possible to produce a highly accurate completed component by using individual parts in which an adjustment site(s) has been appropriately adjusted.

An evaluation site accuracy control method according to the present disclosure is an evaluation site accuracy control method for a completed component that is composed of a combination of a plurality of individual parts, the evaluation site accuracy control method including: a first step for performing finite element analysis to determine an amount of change at evaluation sites of the completed component on a three-dimensional model of the completed component that occurs when displacement is applied to joining areas between the individual parts on the three-dimensional model; a second step for extracting combinations of critical evaluation sites having a relatively large amount of change among the evaluation sites on the three-dimensional model and their corresponding critical joining areas among the joining areas on the three-dimensional model; a third step for generating regression models through Lasso regression using, as explanatory variables for each regression model, actual measurement data of joining areas of uncombined real individual parts corresponding to the critical joining areas and using, as an objective variable for each regression model, actual measurement data of an evaluation site of a real completed component corresponding to the critical evaluation sites; a fourth step for performing Bayesian estimation using each regression model and relationship between the explanatory variables and the objective variable obtained using the actual measurement data to obtain partial regression coefficient probability distribution; and a fifth step for selecting an adjustment site of the individual parts based on mean and spread of the partial regression coefficient probability distribution if the measurement data of the evaluation sites of the completed component includes a value exceeding a permissible value.

This method makes it possible to reduce the number of objective variables by identifying critical evaluation sites and critical joining areas using a three-dimensional model, and to obtain regression models aligned with evaluation on actual parts by incorporating actual measurement data in creating the regression models. This method also makes it possible to select objective variables that take into account tendency of actual parts, which in other words are joining areas of individual parts that have a high contribution to the evaluation sites, by predicting partial regression coefficient probability distribution through Bayesian estimation. As a result, it is possible to effectively adjust an evaluation site.

In the second step of the evaluation site accuracy control method according to the present disclosure, the critical evaluation sites and the critical joining areas may be determined using the amount of change and stiffness relationship between the individual parts in the joining areas.

This method makes it possible to take into account the susceptibility to displacement of the parts relative to each other, which is difficult to determine in an analysis of the completed component, by taking into account the stiffness relationship between the individual parts, allowing identification of more appropriate critical sites. As a result, it is possible to derive regression equations that demonstrate correlation with the actual parts.

In the third step of the evaluation site accuracy control method according to the present disclosure, Lasso regression may be performed using a distance between two joint surfaces at each critical joining area and an amount of deviation of one of the joint surfaces from the reference position.

This method allows for a reduction in the number of factors compared to a method in which regression is performed for each individual part, making it possible to derive accurate regression equations.

According to the present disclosure, it is possible to provide an evaluation site accuracy control method and a production method that allow for deriving regression equations that demonstrate correlation with respect to the part accuracy using a small amount of data.

### BRIEF DESCRIPTION OF THE DRAWINGS

FIG. 1 is a flowchart showing steps of an accuracy control method according to an embodiment of the present disclosure;

FIGS. 2A and 2B are diagrams illustrating an example of welding joints of a completed component;

FIG. 3 is a diagram illustrating an example of evaluation sites of the completed component;

FIG. 4 is a diagram illustrating an example of the amount of change at the evaluation sites;

FIG. 5 is a flowchart showing steps of the accuracy control method according to the present embodiment;

FIG. 6 is a diagram illustrating an example of measurement points of individual parts;

FIG. 7 is a diagram illustrating an example of measurement points of the completed component;

FIG. 8A is a diagram illustrating joint surface accuracy;

FIG. 8B is a diagram illustrating a total gap;

FIG. 9 is a diagram illustrating a beam;

FIG. 10 is a diagram showing posterior distributions obtained through Bayesian estimation;

FIG. 11 is a flowchart showing steps of the accuracy control method according to the present embodiment;

FIG. 12A is a diagram illustrating the completed component; and

FIG. 12B is a diagram illustrating the individual parts that compose the completed component.

### DETAILED DESCRIPTION OF THE INVENTION

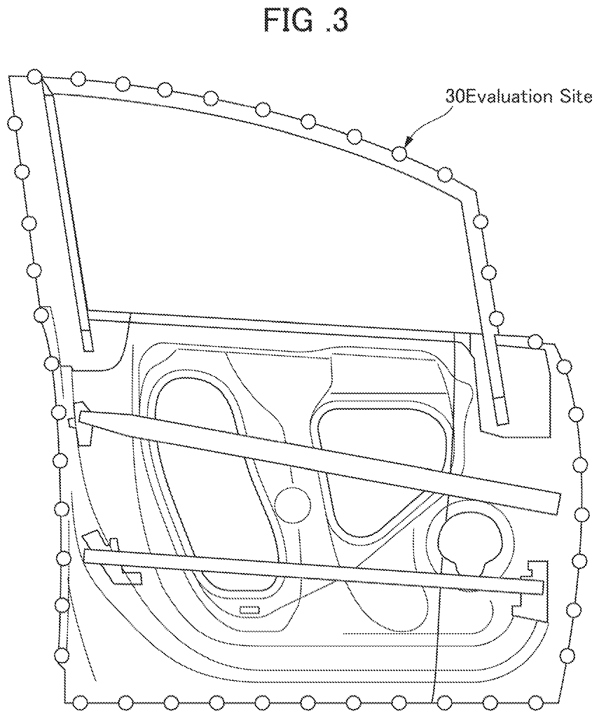

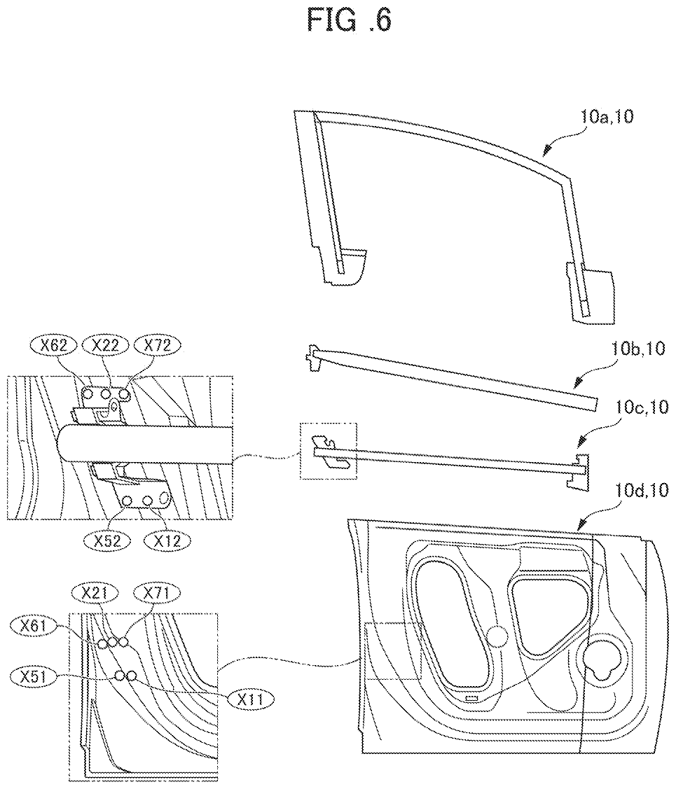

The following describes an evaluation site accuracy control method and a production method according to an embodiment of the present disclosure. The following description discusses, as an example, accuracy control and production of a completed component that is composed of a plurality of individual parts. The following description also discusses, as an example of the completed component, a vehicle door component. FIG. 3 illustrates a door component as a completed component 1. FIG. 6 illustrates individual parts 10 that compose the door component. The door component and the individual parts 10 are described below.

The accuracy control method according to the present disclosure includes the following (1) to (5).
(1) Two indices are calculated and multiplied together based on deformation simulation, and critical sites are extracted. The two indices herein are combined part-to-combined part stiffness ratio and amplification factor. The combined part-to-combined part stiffness ratio is calculated as a ratio between combined parts with respect to force exerted when a specific amount of displacement is applied to the combined parts. The amplification factor is calculated as a ratio of the amount of movement of observation sites that occurs when the specific amount of displacement is applied to joint surfaces.

(2) A door component is measured using a three-dimensional measuring instrument by associating individual parts with a completed component. Then, objective variables Yk and explanatory variables Xij are acquired.

(3) Polynomial equations for the objective variables Yk and the explanatory variables Xij are obtained through regression using the analysis results from the simulation in (1) and the measurement data obtained in (2).

(4) For each polynomial equation obtained in (3), posterior probability distributions of contribution are estimated through Bayesian estimation.

(5) A critical control site is identified using the 95% credibility interval of each posterior probability distribution.

(1) and (2) described above include first and second steps described below. (3) includes a third step. (4) and (5) include a fourth step. In the first step, displacement is applied to joining areas on a three-dimensional model of the completed component, and the amount of change at evaluation sites is obtained. In the second step, combinations of critical joining areas and critical evaluation sites are extracted. In the third step, Lasso regression models are generated using, as explanatory variables for each Lasso regression model, actual measurement data of the critical joining areas of the parts and using, as an objective variable for each Lasso regression model, actual measurement data of a critical evaluation site of the completed component. In the fourth step, Bayesian estimation is performed to obtain partial regression coefficient probability distribution. In the fifth step, an adjustment site of the individual parts is selected based on the mean and spread of the partial regression coefficient probability distribution. A production method according to the present embodiment includes the first to fifth steps of the accuracy control method, and further includes, after the fifth step, a sixth step for producing the completed component using the individual parts in which the adjustment site has been adjusted.

The accuracy control method according to the present embodiment makes it possible to create regression models aligned with the actual parts by adding actual measurement data when creating the regression models. Furthermore, the accuracy control method makes it possible to effectively adjust an evaluation site by predicting partial regression coefficient probability distribution through Bayesian estimation. The following describes each step in order.

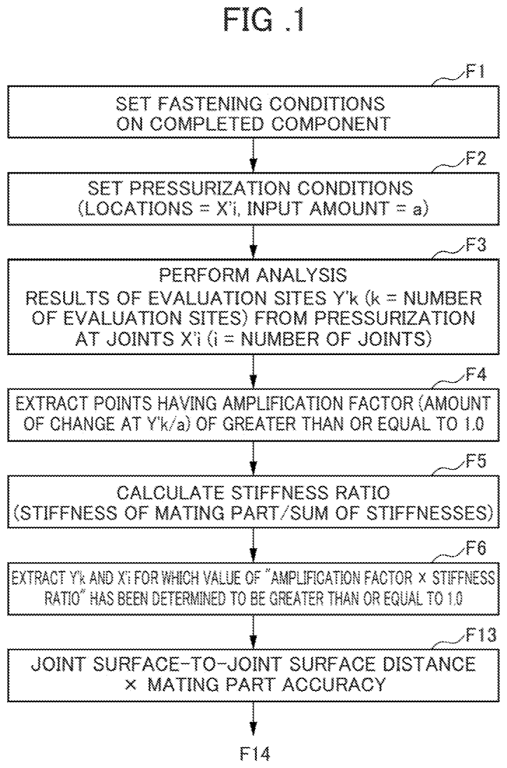

FIG. 1 is a flowchart showing steps of the accuracy control method according to the present embodiment. Specifically, FIG. 1 is a diagram showing procedures for extracting combinations of critical joining areas and critical evaluation sites. The accuracy control method according to the present embodiment is described using an example in which the accuracy of evaluation sites 30 of a completed component 1 that is composed of a combination of a plurality of individual parts 10 is controlled.

(First Step)

In the first step, finite element analysis is performed to determine the amount of change at the evaluation sites 30 of the completed component 1 on a three-dimensional model of the completed component 1 that occurs when displacement is applied to joining areas, which in other words are welding joints 20, between the individual parts 10 on the three-dimensional model. The first step involves the following procedures F1 to F4.

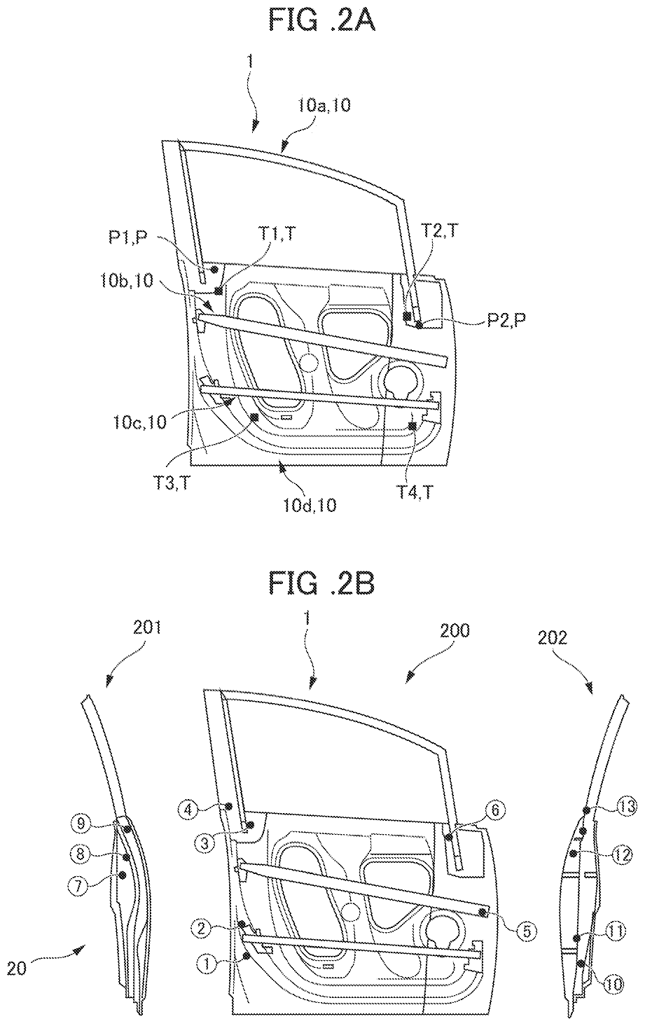

(F1) First, in F1 shown in FIG. 1, fastening conditions for the individual parts 10 are set. FIGS. 2A and 2B illustrate a door inner panel component as an example of the completed component 1. Specifically, FIG. 2A illustrates the completed component 1 and the individual parts 10 that compose the completed component 1. FIG. 2B illustrates an example of joints to be used in the analysis, which in other words are welding joints 20. Hereinafter, the welding joints 20 may also be simply referred to as joints. The reference numeral 200 in FIG. 2B represents an inside front surface of the completed component 1, and the reference numerals 201 and 202 in FIG. 2B respectively represent side surfaces of the completed component 1. The word “inside” refers to an inner side of a vehicle with the door component described as the completed component 1 attached thereto.

As shown in FIG. 2A, the completed component 1 is composed of the plurality of individual parts 10 such as those denoted by 10a to 10d. Points indicated by respective circled numbers in FIG. 2B represent the welding joints 20. The completed component 1 is formed by welding the individual parts 10 together at the plurality of welding joints 20.

“P” in FIG. 2A represents a reference pin, and “T” represents the position of a receiving surface. The reference pins P and the receiving surfaces T are used to fix an object, such as the completed component 1, when the object is measured. In FIG. 2A, a main reference pin P1 and a sub-reference pin P2 are shown as examples of the reference pins P. As the fastening conditions in F1 for the analysis, complete fastening is set in four receiving surfaces T1 to T4 at four locations as well as holes of the main reference pin P1 and the sub-reference pin P2.

(F2) Next, pressurization conditions are set in F2. Specifically, pressurization locations X′i and an input amount a are set. The pressurization locations X′i correspond to the welding joints 20, which in other words are the joining areas. The input amount a means the amount of displacement of the welding joints 20 to be caused by the pressurization.

(F3) Next, the pressurization and the analysis are performed in F3. In F3, the analysis is performed using forced displacement. The term “forced displacement” as used herein refers to an analysis that involves, rather than applying force, forcibly pulling the shape of an object in a specific direction (direction normal to joint surfaces) by the input amount a, and thus creating a state in which a tensile load is applied on the interior of the object. Performing the analysis using forced displacement allows for maintaining the uniform input value a for the amount of displacement among the joint surfaces, thereby reducing the time and effort required to calculate amplification factor. For example, the forced displacement is applied to the welding joints 20 at the respective locations X′i (i=the number of joints) as shown in FIG. 2B. Then, the amount of change at evaluation sites Y′k (k=the number of evaluation sites) that occurs when the displacement is applied to the joints is analyzed.

(F4) Next, points having an amplification factor of greater than or equal to 1.0 are extracted in F4. The amplification factor is “amount of change at evaluation site Y′k/input amount (a)”. In a case where an analysis using an applied pressure as an input value (analysis using concentrated load) is performed instead of the analysis using forced displacement, the amplification factor is “amount of change at evaluation site Y′k/amount of displacement at location X′i subjected to pressurization”.

FIG. 3 illustrates an example of an arrangement of the evaluation sites 30 of the completed component 1. As shown in FIG. 3, in a case where the completed component 1 is a door inner panel component, the evaluation sites 30 can be located on the edge of the door inner panel component. The evaluation sites 30 can be, for example, arranged at a pitch of 10 mm.

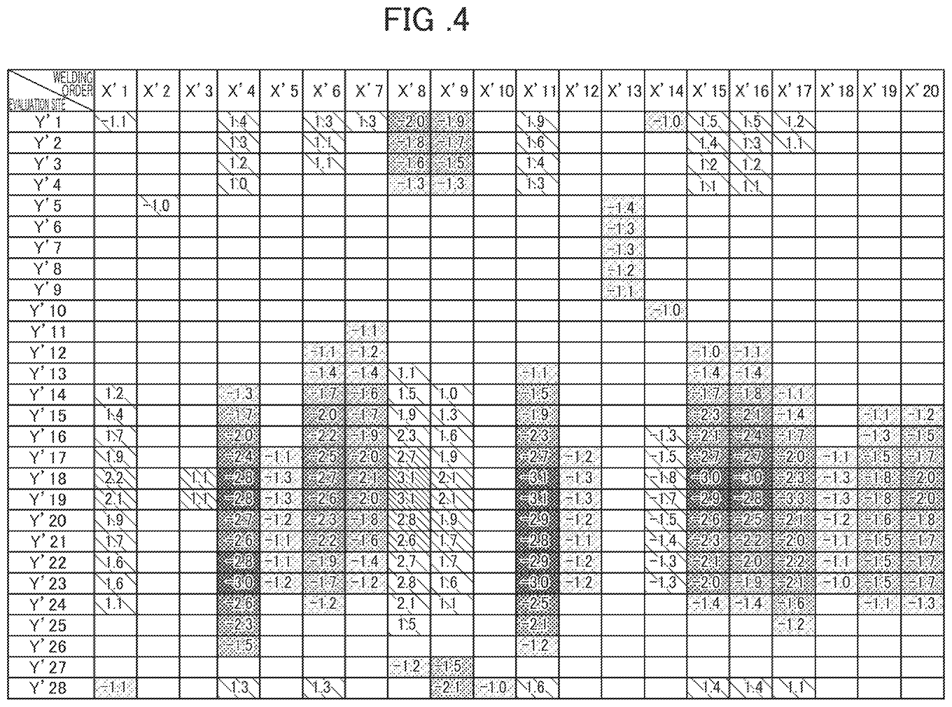

FIG. 4 illustrates an example of the amount of change at the evaluation sites 30 that occurs when displacement is applied to the welding joints 20. A row of a table shown in FIG. 4 indicates the locations of the welding joints 20. A column of the table shown in FIG. 4 indicates the evaluation sites 30. Numerical values in the table indicate amplification factors. Blank cells in the table indicate an amplification factor of less than or equal to 1.0 as an absolute value. FIG. 4 indicates that displacement applied to the welding joints 20 results in an amplification factor of greater than 1.0 at evaluation sites 30 in the vicinity of the welding joints 20. The intensity of shading in FIG. 4 indicates the magnitude of the amplification factor, with a darker shaded area indicating a greater amplification factor and a lighter shaded area indicating a smaller amplification factor. The shading shows that the amplification factor of the evaluation sites 30 gradually decreases in a certain range to be 1.0 or less.

(Second Step)

In the second step, combinations of critical evaluation sites having a relatively large amount of change among the evaluation sites 30 on the three-dimensional model of the completed component 1 and their corresponding critical joining areas among the joining areas 20 on the three-dimensional model are extracted. Preferably, each of the combinations is extracted by determining a critical evaluation site and critical joining areas using the amount of change and the stiffness relationship between the individual parts 10 in the joining areas 20. The analysis using forced displacement assumes that pressurization points (X′i) move according to the input amount a. However, in the actual analysis, the movement of the pressurization points can be hindered due to the stiffness relationship between plate materials of the individual parts. Specifically, the parts can move closer to each other in a case where the parts before joining have a level of accuracy that results in a gap therebetween, and the parts can be pressed against each other, causing a joining surface therebetween to move toward the stiffer part in a case where the parts interfere with each other. A stiffness ratio therebetween is therefore calculated and added to the analysis. The second step involves the following procedures F5 to F12.

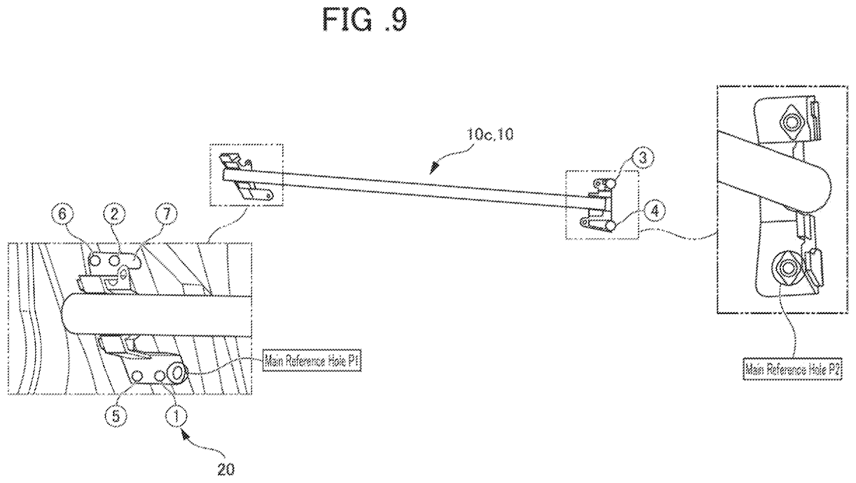

(F5) First, the stiffness ratio is calculated in F5 in FIG. 1. The stiffness ratio means “stiffness of mating part/sum of stiffnesses”. The term “mating part” means a small part that is attached to a reference part. The small part means a part having a smaller size, such as a sash or a beam, among the individual parts 10. The stiffness means a load (N) required to cause a displacement of 0.5 mm at the joints on each individual part. An example of the fastening conditions is shown using a beam in FIG. 9. For the first joint, the holes of the main reference pin P1 and the sub-reference pin P2 are completely fastened to perform the analysis. For the second joint, the holes of the main reference pin P1 and the sub-reference pin P2 are completely fastened, and the first joint is additionally fastened to perform the analysis. For the third joint, the second joint is additionally fastened. Thus, for the subsequent joints, the number of joints to be fastened increases one by one. The sum of stiffnesses refers to the sum of the stiffness (N) of the small part and the stiffness (N) of the reference part. It should be noted here that the reference part means a part having a larger size, such as a door panel, among the individual parts 10. FIG. 6 illustrates an example of the individual parts 10. In FIG. 6, the individual part 10a represents a sash, the individual part 10b represents a stiffener, the individual part 10c represents a beam, and the individual part 10d represents a door panel. In these examples, the sash represented by the individual part 10a, the stiffener represented by the individual part 10b, and the beam represented by the individual part 10c are classified as small parts. The door panel represented by the individual part 10d is classified as a reference part. The analysis of the stiffness is performed separately for small parts and for parts that are combined with small parts. Sites having a higher stiffness ratio are less likely to move toward the reference part in a case where the parts before joining have a level of accuracy that results in a gap therebetween. That is, such sites are not easily affected by the accuracy of the mating part after joining, meaning that the accuracy of the individual parts directly affects the accuracy of the evaluation sites. It is therefore possible to derive regression equations that demonstrate correlation with the accuracy of the actual individual parts as a result of extracting such sites as critical sites.

(F6) Next, Y′k and X′i for which the value of “amplification factor× stiffness ratio” has been determined to be greater than or equal to 1.0 are extracted in F6. That is, the determination of critical evaluation sites is made based on the amplification factor that takes into account the stiffness ratio rather than solely relying on the amplification factor. A table such as shown in FIG. 4 may be used for the extraction. Only those with significant impact are extracted for each evaluation site. Overall, 20 X′i are selected in order of impact per evaluation site Y′.

The above-described method allows the stiffness relationship between the individual parts 10 to be taken into account. Thus, the susceptibility to displacement of the parts relative to each other, which is difficult to determine in an analysis of the completed component 1, can be taken into account. It is therefore possible to more accurately identify critical sites. As a result, it is possible to derive regression equations that more closely approximate the correlation with the actual parts.

It should be noted that in the second step, combinations of critical evaluation sites and critical joining areas may be extracted using only the amplification factor, without using the stiffness ratio.

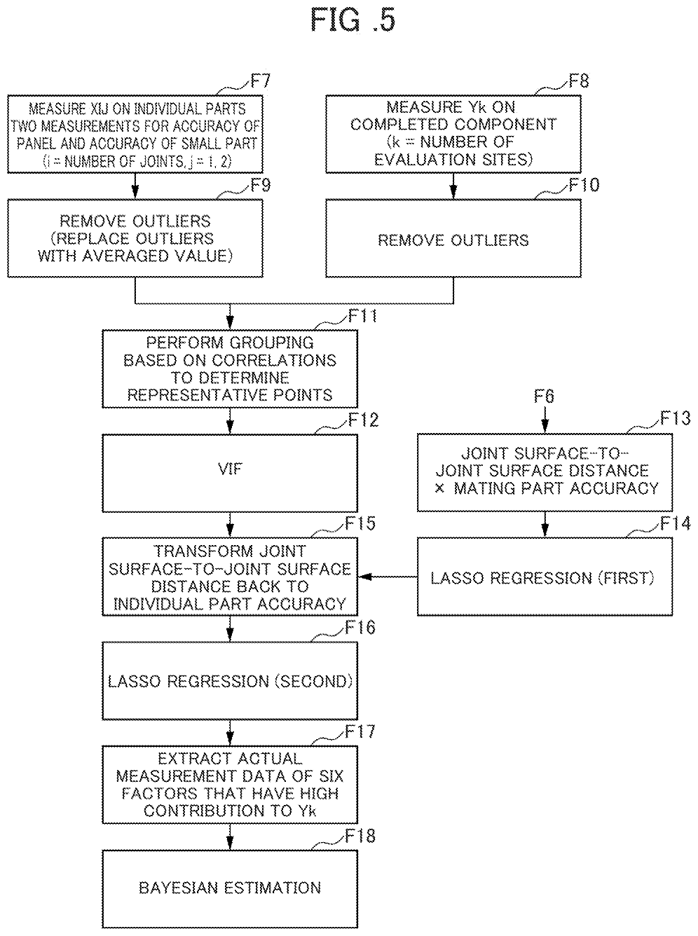

Actual Measurement Data Measurement flow The following describes an actual measurement data measurement flow based on FIG. 5. FIG. 5 is a flowchart showing steps of the accuracy control method according to the present embodiment. Specifically, FIG. 5 is a diagram showing the actual measurement data measurement flow. In the actual measurement data measurement flow, a three-dimensional measuring instrument is used to measure door parts by associating individual parts 10 with a completed component as the completed component 1 to obtain explanatory variables Xi and objective variables Yi. It should be noted that the measurement in this flow is performed to measure the accuracy, which is the amount of deviation from a designed reference position.

(F7) First, in F7 shown in FIG. 5, Xij are measured at the joining areas, which in other words are the welding joints 20, of the individual parts 10. This measurement involves two measurements per welding joint 20. One of the measurements is performed to measure accuracy Xi1 on joint surfaces of a door panel, and the other is performed to measure accuracy Xi2 on joint surfaces of a small part. The measurement is therefore performed twice, a measurement (j=1) for the reference part and a measurement (j=2) for the small part per i=welding joint number. FIG. 6 is a diagram illustrating examples of the individual parts 10 and measurement points thereon, which are referred to as X measurement points 12. Xi1 and Xi2 in the actual measurement data measurement flow correspond to X′i in the three-dimensional model used in the first step. In FIG. 6, as an example of inputs: Xij, inputs: X11 to X71 are appended as X measurement points 12 with respect to the measurement points (joint surfaces) of the door panel represented by the individual part 10d (reference part), and inputs: X12 to X72 are appended as X measurement points 12 with respect the measurement points (joint surfaces) of the beam represented by the individual part 10c (small part). As mentioned above, the individual part 10a in FIG. 6 represents the sash, the individual part 10b represents the stiffener, the individual part 10c represents the beam, and the individual part 10d represents the door panel. The sash represented by the individual part 10a, the stiffener represented by the individual part 10b, and the beam represented by the individual part 10c are small parts relative to the door panel represented by the individual part 10d, which is the reference part.

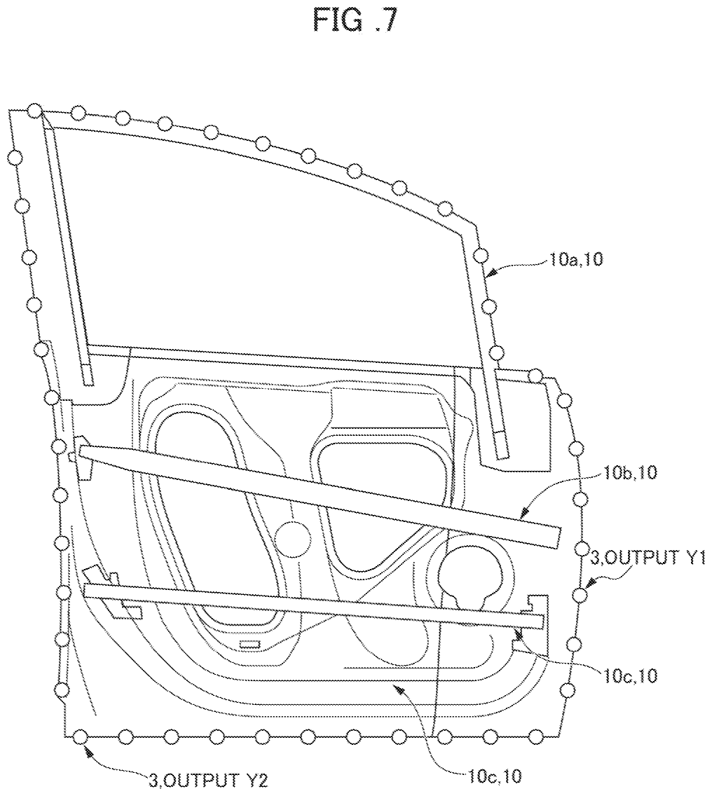

(F8) Next, in F8, Yk are measured at Y measurement points 3, which are measurement points of the completed component 1. It should be noted that k represents the number of evaluation sites. FIG. 7 is a diagram illustrating examples of the completed component 1 and the measurement points 3. Yk in the actual measurement data measurement flow corresponds to Y′k in the three-dimensional model used in the first step. In FIG. 7, as an example of outputs: Yk, outputs: Y1 and Y2 are appended to the measurement points 3. The number of samples to be measured in F7 and F8 may be, for example, 15.

(F9) Next, in F9, outliers are removed from the Xij measured in F7. Specifically, such measurement values are each replaced with an averaged value.

(F10) Next, as in F9, outliers are removed from Yk measured in F8 in F10.

(F11) Next, in F11, grouping is performed based on correlations to determine representative points. Specifically, pairs of variables with similar correlation coefficients are grouped together into one correlation group. For example, two adjacent Xij in the same individual part 10c that have measurement values with similar correlations, such as X11 and X51 in FIG. 6, can be grouped into one correlation group. In F11, representative points are set for the correlation groups each including variables grouped together. It should be noted that the grouping is not mandatory. However, reducing the number of variables through grouping or the like allows for more accurate calculation.

(F12) Next, in F12, the presence or absence of multicollinearity is checked using a variance inflation factor (VIF). If multicollinearity is observed, one of compared variables may be removed as appropriate. In F12, correlations are assessed by comparing one variable against multiple others. In F11 and F12, there can be a discrepancy between the welding joints 20 having a high contribution determined based on computer aided engineering (CAE) analysis results and the representative points determined through the grouping and using the VIF. In such a case, the numerical value of the representative point determined to have a higher correlation in a group including a welding joint 20 having a high contribution is adopted.

(Third Step)

In the third step, regression models are generated through Lasso regression using, as explanatory variables for each regression model, actual measurement data of joining areas 20 of uncombined real individual parts 10 corresponding to the critical joining areas and using, as an objective variable for each regression model, actual measurement data of an evaluation site 30 of a real completed component 1 corresponding to the critical evaluation sites. The third step involves the following procedures F13 to F17.

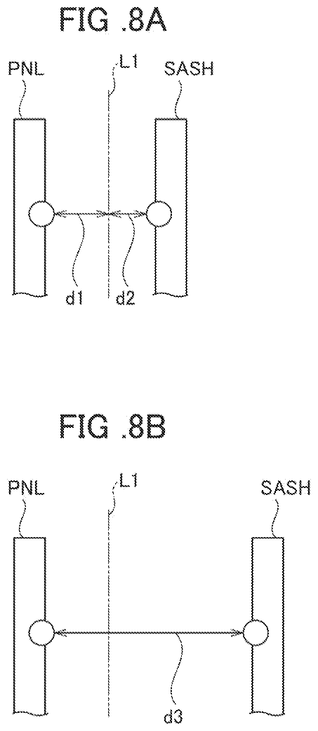

In the third step, preferably, Lasso regression is performed using the distance between two joint surfaces at each critical joining area and the amount of deviation of one of the joint surfaces from the reference position. This is because this method allows for a reduction in the number of factors compared to a method in which regression is performed for each individual part, making it possible to derive more accurate regression equations. FIG. 8A is a diagram illustrating joint surface accuracy. FIG. 8B is a diagram illustrating joint surface-to-joint surface distance. In FIGS. 8A and 8B, PNL indicates the door panel. SASH indicates the sash, which is the mating part. A line L1 indicates the reference position (designed reference). As shown in FIG. 8A, PNL is at a distance d1 from the reference position L1. SASH is at a distance d2 from the reference position L1. The amount of deviation of PNL and SASH is d1+d2. Thus, using the distances from the reference position L1, the distance between PNL and SASH is represented by two variables, d1 and d2.

The distance between PNL and SASH can be indicated without using the reference position L1. That is, the distance can be directly indicated by d3 as shown in FIG. 8B.

d3 corresponds to d1+d2 in FIG. 8A. This directly indicated distance between PNL and SASH is taken as a joint surface-to-joint surface distance. The number of variables, which in other words is the number of factors, can be halved by indicating the distance between PNL and SASH as the joint surface-to-joint surface distance. The number of factors for joint surface accuracy in each part can range from 60 to 70 at the highest. The use of the joint surface-to-joint surface distance can half the number of factors to approximately 30.

(F13) In F13 shown in FIG. 5, the data obtained by removing the outliers in F9 is transformed into “joint surface-to-joint surface distance×mating part accuracy”. As described above, the joint surface-to-joint surface distance refers to the total amount of deviation of the two surfaces. The mating part accuracy refers to the position of the mating part relative to PNL. This transformation makes it possible to determine the accuracy with respect to designed values while reducing the number of factors.

(F14) Next, in F14, the first Lasso regression is performed using values processed in F13. Specifically, measurement data (for 15 samples) of Xij of the individual parts related to Y′k and X′in having a high value of “amplification factor×stiffness ratio” is extracted. Then, the values of the mating part accuracy based on the joint surface-to-joint surface distance are calculated to perform the regression.

(F15) Next, in F15, the joint surface-to-joint surface distance is transformed back to individual part accuracy. Specifically, the single variable obtained through the transformation to “joint surface-to-joint surface distance x mating part accuracy” in F13 is treated as separate factors for PNL and SASH.

(F16) Next, in F16, the second Lasso regression is performed. The number of factors is reduced, and the values of 13 that demonstrate correlation are calculated using the reduced number of factors. It should be noted that the Lasso regression can be performed in F16 without the need to go through F13 to F15, i.e., without performing the data processing in F9.

(F17) Then, in F17, polynomial equations for objective variables Yk and explanatory variables Xij are obtained using the actual measurement data, which in other words is the aforementioned measurement data. For each Yk, actual measurement data of six factors that have a high contribution to the Yk is extracted. An example of the polynomial equations to be obtained is as follows:

Y=β₁X₁+β₂X₂+β₃X₃+β₄X₄+β₅X₅+β₆X₆.

β represents a partial regression coefficient and X represents a contributing factor. Specifically, a polynomial equation of explanatory variables Xij is obtained for each objective variable Yk, such as Y2=β₁X11+β₂ X21+β₃ X22+β₄ X32+β₅ X41+β₆ X52 or Y4=β₁ X42+β₂ X51+β₃ X52+β₄ X62+β₅ X71+β₆ X72. The values of β₁ to β₆ are different for each objective variable Yk. The explanatory variables Xij can include variables Xi1 and Xi2.

(Fourth Step)

In the fourth step, Bayesian estimation is performed using each regression model and the relationship between the explanatory variables and the objective variable obtained using the actual measurement data to obtain partial regression coefficient probability distribution. The fourth step involves the following procedure F18.

(F18) Bayesian estimation is performed in F18. When performing the Bayesian estimation, for example, a Markov Chain Monte Carlo (MCMC) method, which includes processing of randomly increasing samples, may be used. In the Bayesian estimation, a prior distribution is set to be a probability distribution where the values of the partial regression coefficients calculated in the Lasso regression form the peak of a normal distribution.

(Fifth Step)

In the fifth step, if the measurement data of the evaluation sites 30 of the completed component 1 includes a value exceeding a permissible value, an adjustment site of the individual parts 10 is selected based on the mean and spread of the partial regression coefficient probability distribution. The fifth step involves the following procedures F19 to F31. The fifth step involves model probability distribution estimation, adjustment site selection, and adjustment amount determination.

Model Probability Distribution Estimation

The following describes the model probability distribution estimation.

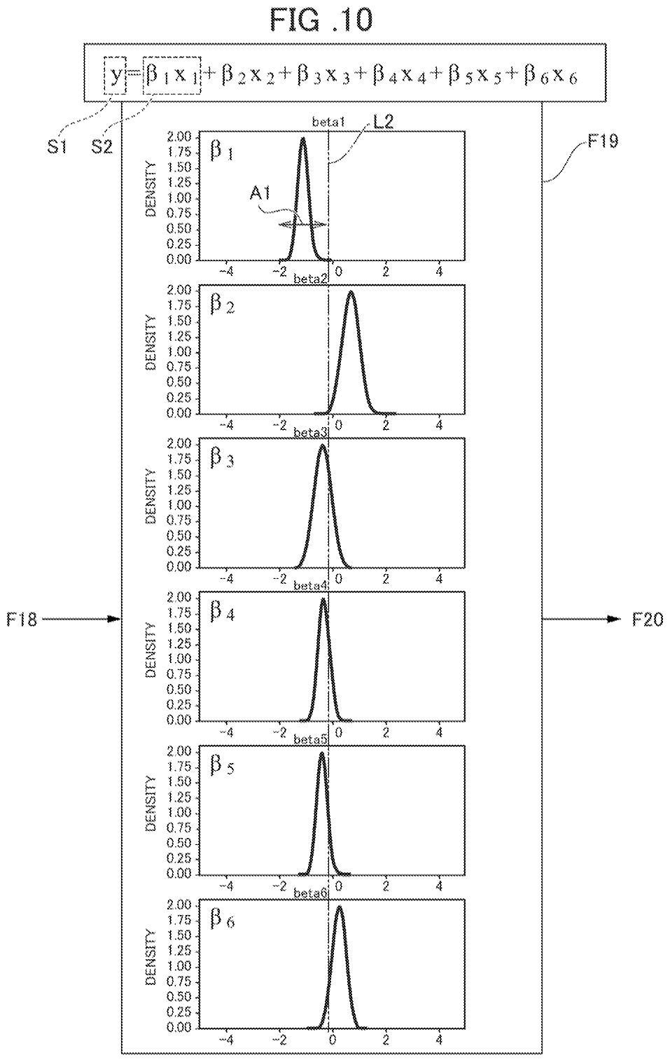

(F19) First, in F19 shown in FIG. 10, posterior distributions are obtained through Bayesian estimation. FIG. 10 is a diagram showing the posterior distributions obtained through Bayesian estimation. FIG. 10 shows the posterior distributions obtained through Bayesian estimation for β₁ to β₆, respectively, in the polynomial equation described in association with F17 (also shown at the top of FIG. 10). The horizontal axis of each graph represents random variable and the vertical axis represents probability density. A line L2 shown in FIG. 10 indicates where the random variable is zero. β₁ to β₆ correspond to the six factors with the highest contribution in the partial regression coefficient probability distribution.

Adjustment Site Selection

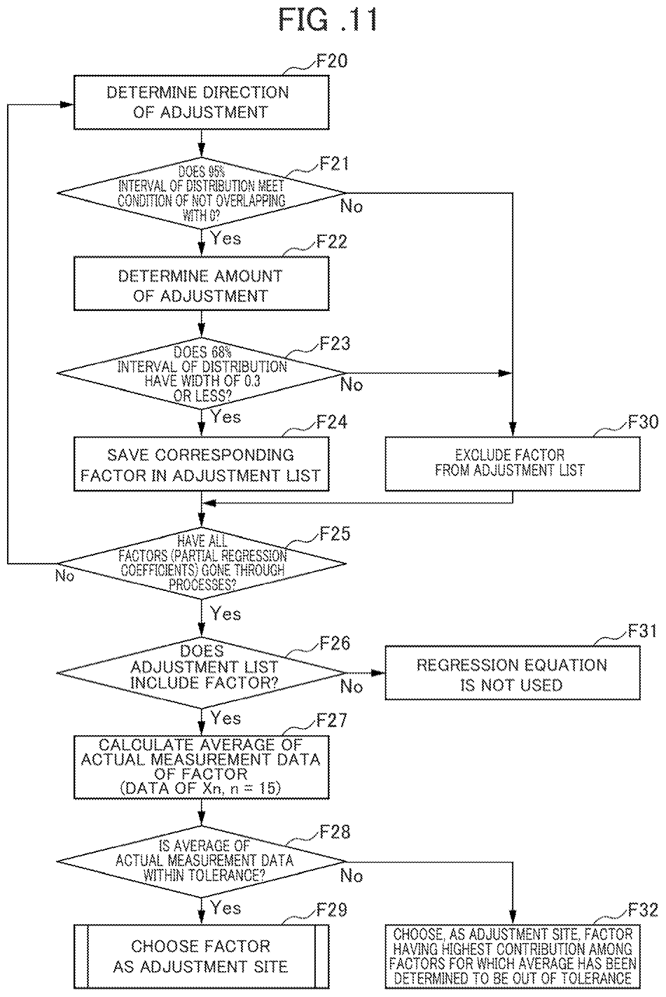

The following describes the adjustment site selection. FIG. 11 is a flowchart showing steps of the accuracy control method according to the present embodiment. Specifically, FIG. 11 is a diagram showing processing from the adjustment site selection to the adjustment amount determination.

(F20) In F20, the direction of adjustment is determined. Specifically, it is determined whether or not the 95% interval of the probability density distribution in a posterior distribution meets a condition of not overlapping with “random variable=0”. The graph for β₁ in FIG. 10 represents an example of the partial regression coefficient probability distribution where the 95% interval of the probability density distribution in the posterior distribution does not overlap with “random variable=0”. In the graph for β₁ in FIG. 10, the entire probability distribution is located on one of two sides, with “random variable=0” serving as the boundary between the two sides. Specifically, the probability distribution is located on the negative side of “random variable=0”. A significant portion of the probability distribution not overlapping with “random variable=0” indicates that adjustment control is easier.

(F21) In F21, the determination regarding F20 is made. Specifically, if the 95% interval of the probability density distribution in the posterior distribution does not overlap with “random variable=0”, the result of the determination in F21 is positive, or Yes. If the 95% interval of the probability density distribution overlaps with “random variable=0”, the result of the determination in F21 is negative, or No.

(F30) If the result of the determination in F21 is negative, or No, the processing continues to F30, and the factor is excluded as an adjustment candidate.

(F22) If the result of the determination in F21 is positive, or Yes, the processing continues to F22. In F22, the amount of adjustment is determined. The graph for β₁ in FIG. 10 represents an example of the partial regression coefficient probability distribution where the 68% interval of the probability density distribution in the posterior distribution has a width of 0.3 or less in terms of the range of the random variable. The horizontal axis of each graph shown in FIG. 10 represents random variable and the vertical axis represents probability density. The line L2 indicates where the random variable is zero. A double-headed arrow A1 in the graph for β₁ shown in FIG. 10 indicates the interval where the probability density distribution is 68%. A probability density distribution being sharp rather than broad, as in the graph for β₁ shown in FIG. 10, means that the determination regarding the adjustment can be accurately made.

(F23) In F23, the determination regarding F22 is made. Specifically, if the 68% interval of the probability density distribution in the posterior distribution has a width of 0.3 or less in terms of the range of the random variable, the result of the determination in F23 is positive, or Yes. If the 68% interval of the probability density distribution in the posterior distribution has a width of greater than 0.3 in terms of the range of the random variable, the result of the determination in F23 is negative, or No.

(F30) If the result of the determination in F23 is negative, or No, the processing continues to F30, and the factor is excluded as an adjustment candidate.

(F24) If the result of the determination in F23 is positive, or Yes, the processing continues to F24. In F24, a task to save the contributing factor X corresponding to the partial regression coefficient in a list as an adjustment candidate is performed. For example, if β₁ meets the conditions described in F21 and F23, X1 corresponding to β₁ is saved in the adjustment list. If a partial regression coefficient β other than β₁ meets the aforementioned conditions, X corresponding to this partial regression coefficient β is also saved.

(F25) Next, in F25, it is determined whether or not all the partial regression coefficients β₁ to β₆ have gone through the processes up to F22 and F24. If any of the partial regression coefficients has not gone through the processes, the result of the determination in F25 is No, and the processing returns to F20. If the result of the determination in F25 is Yes, the processing continues to F26.

(F26) Next, in F26, a determination is made as to whether or not the adjustment list includes a factor. If the result of the determination in F26 is No, the number of factors is increased and the processes up to F22 and F24 are repeated. Alternatively, the processing continues to F31, and a joining area for which the value of “amplification factor×stiffness ratio” calculated in F1 to F6 has been determined to be large and the average of the actual measurement data has been determined to be out of tolerance is selected, without using the regression equation.

(F27) If the result of the determination in F26 is Yes, the processing continues to F27. In F27, the average of the actual measurement data of the contribution meeting the conditions is calculated. For example, the calculation is performed using the data of Xn, where N=15. Then, in F27, if 131 meets the conditions described in F22 and F24, for example, it is determined whether or not the average of the actual measurement data of X1 corresponding to β₁ is out of tolerance.

(F28) In F28, the determination regarding F27 is made. If the result of the determination for the average of the actual measurement data in F27 is out of tolerance, or No, the processing continues to F32, and the factor having the highest contribution among the factors for which the average has been determined to be out of tolerance is chosen as an adjustment site.

(F29) If the result of the determination in F28 is within torelence, or Yes, the processing continues to F29. In F29, the factor is chosen as an adjustment site. It should be noted that the adjustment is not limited to being performed on Xi, and may be performed on a plurality of Xn. Accordingly, the aforementioned flow can be performed for other βₙ than β₁. In some cases, such as when the average of the actual measurement data is determined to be within tolerance for all of βₙ to β₆ corresponding to β₁ to β₆, the adjustment using the regression equation is not performed.

Adjustment Amount Determination

The following describes the adjustment amount determination. The adjustment amount determination can be made, for example, as follows. Specifically, the polynomial equation Y=β₁X₁+β₂X₂+β₃X₃+β₄X₄+β₅X₅+β₆X₆ obtained in F17 is used to determine the amount of adjustment. The following considers, for example, a case where for a site Y to be adjusted, the partial regression coefficient having a high contribution is 31, and X₁ corresponding to β₁ is adjusted to adjust Y among the adjustment sites determined in F29 or F32. In this case to be considered, the current gap at the site Y to be adjusted, which in other words is the gap before adjustment, is 0.59 mm, and this gap is adjusted to 0 mm.

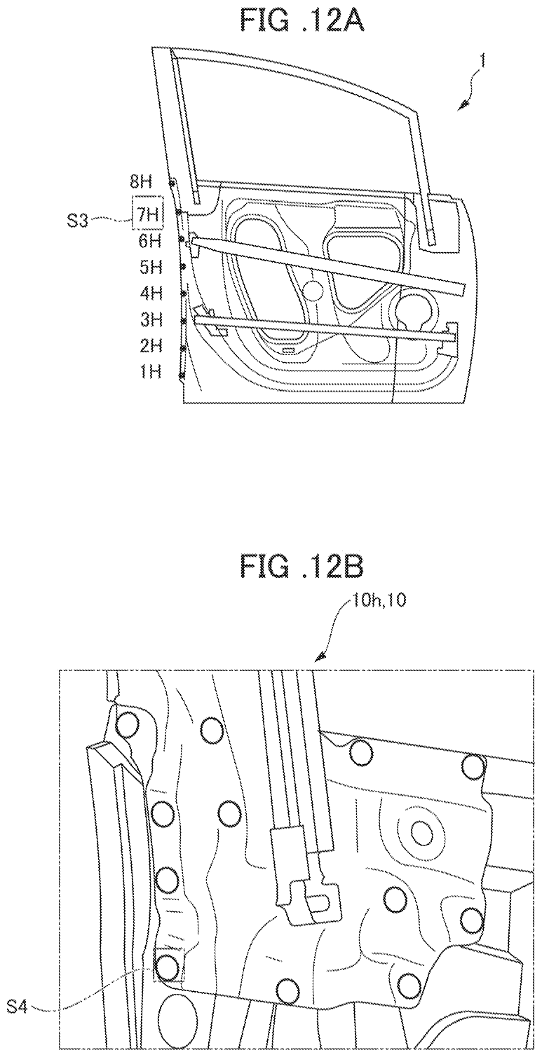

FIG. 12A is a diagram illustrating an example of the completed component 1, and FIG. 12B is a diagram illustrating the individual parts 10 that compose the completed component 1. To illustrate the case mentioned as an example above using the drawings, a point 7H enclosed in a square S3 in FIG. 12A is Y, and the gap at Y is 0.59 mm.

In this example, the partial regression coefficient β₁ is −1.1. The following focuses on a portion of the polynomial equation, Y=β₁X₁. In FIG. 10, a square Si indicates Y, and a square S2 indicates β₁X₁ in F19. The gap before adjustment is 0.59 mm, and the target gap is 0 mm. Accordingly, the desired moving distance is “0.59 mm−0 mm=0.59 mm”. The desired moving distance 0.59 mm is inputted for Y, and −1.1 is inputted for β₁. This gives 0.59=−1.1×X₁, resulting in X₁=−0.53 mm. The result shows that the site X1 needs to be adjusted by −0.53 mm in order to move Y by −0.59 mm. Assume that a portion corresponding to the site X1 is a point, or a joining area, enclosed in a square S4 (marked with an X in a circle) of the individual part 10d shown in FIG. 12B. In this case, the point 7H, which is Y, can be adjusted by−0.59 mm by adjusting this point by −0.53 mm. That is, the square Si in FIG. 10 corresponds to the square S3 in FIG. 12A, and the square S2 in FIG. 10 corresponds to the square S4 in FIG. 12B. As described above, for example, it is possible to identify a critical control site and determine the amount of adjustment based on the critical control site by utilizing the 95% credibility interval of the posterior probability distribution.

It should be noted that a case where two or more partial regression coefficients β have a high contribution to the site Y to be adjusted in Y=β₁X₁+β₂X₂+β₃X₃+β₄X₄+β₅X₅+(β₆X₆ can be handled as follows. For example, β₁ and β₃ can be partial regression coefficients β having a high contribution. In this case, either X₁ corresponding to β₁ or X3 corresponding to β₃ may be adjusted to adjust Y. Alternatively, both X₁ corresponding to β₁ and X3 corresponding to β₃ may be adjusted.

Xn to be adjusted may be a point of Xij. That is, Xn to be adjusted may be either Xi1 or Xi2.

(Sixth Step)

In the sixth step, the individual parts 10 in which the adjustment site has been adjusted are used to produce the completed component 1. The above-described method makes it easy to produce the completed component 1 within tolerance.

### EXPLANATION OF REFERENCE NUMERALS

1: Completed component
3: Y measurement point
10: Individual part
12: X measurement point
20: Welding joint (joining area, joint)
30: Evaluation site
35
P: Reference pin
P1: Main reference pin
P2: Sub-reference pin
T: Receiving surface

What is claimed is:

1. A production method for a completed component that is composed of a combination of a plurality of individual parts, the production method comprising:
a first step for performing finite element analysis to determine an amount of change at evaluation sites of the completed component on a three-dimensional model of the completed component that occurs when displacement is applied to joining areas between the individual parts on the three-dimensional model;
a second step for extracting combinations of critical evaluation sites having a relatively large amount of change among the evaluation sites on the three-dimensional model and their corresponding critical joining areas among the joining areas on the three-dimensional model;
a third step for generating regression models through Lasso regression using, as explanatory variables for each regression model, actual measurement data of joining areas of uncombined real individual parts corresponding to the critical joining areas and using, as an objective variable for each regression model, actual measurement data of an evaluation site of a real completed component corresponding to the critical evaluation sites;
a fourth step for performing Bayesian estimation using each regression model and relationship between the explanatory variables and the objective variable obtained using the actual measurement data to obtain partial regression coefficient probability distribution;
a fifth step for selecting an adjustment site of the individual parts based on mean and spread of the partial regression coefficient probability distribution if the measurement data of the evaluation sites of the completed component includes a value exceeding a permissible value; and
a sixth step for producing the completed component using the individual parts in which the adjustment site has been adjusted.

2. An evaluation site accuracy control method for a completed component that is composed of a combination of a plurality of individual parts, the evaluation site accuracy control method comprising:
a first step for performing finite element analysis to determine an amount of change at evaluation sites of the completed component on a three-dimensional model of the completed component that occurs when displacement is applied to joining areas between the individual parts on the three-dimensional model;
a second step for extracting combinations of critical evaluation sites having a relatively large amount of change among the evaluation sites on the three-dimensional model and their corresponding critical joining areas among the joining areas on the three-dimensional model;
a third step for generating regression models through Lasso regression using, as explanatory variables for each regression model, actual measurement data of joining areas of uncombined real individual parts corresponding to the critical joining areas and using, as an objective variable for each regression model, actual measurement data of an evaluation site of a real completed component corresponding to the critical evaluation sites;
a fourth step for performing Bayesian estimation using each regression model and relationship between the explanatory variables and the objective variable obtained using the actual measurement data to obtain partial regression coefficient probability distribution; and
a fifth step for selecting an adjustment site of the individual parts based on mean and spread of the partial regression coefficient probability distribution if the measurement data of the evaluation sites of the completed component includes a value exceeding a permissible value.

3. The evaluation site accuracy control method according to claim 2, wherein in the second step, the critical evaluation sites and the critical joining areas are determined using the amount of change and stiffness relationship between the individual parts in the joining areas.

4. The evaluation site accuracy control method according to claim 2, wherein in the third step, Lasso regression is performed using a distance between two joint surfaces at each critical joining area and an amount of deviation of one of the joint surfaces from a reference position.
